(19) United States
(12) Patent Application Publication
(10) Pub. No.: US 2016/0227150 A1
(43) Pub. Date: Aug. 4, 2016

(54) METHOD AND DEVICE FOR REMOTE CONTROL

(71) Applicant: Xiaomi Inc., Beijing (CN)

(72) Inventors: Guang SUN, Beijing (CN); Renjie CAI, Beijing (CN); Tiejun LIU, Beijing (CN)

(73) Assignee: Xiaomi Inc.

(21) Appl. No.: 14/992,368

(22) Filed: Jan. 11, 2016

(30) Foreign Application Priority Data
Jan. 29, 2015 (CN) 201510047939.8

(51) Int. Cl. H04N 5/44; G06F 3/01

(52) U.S. Cl. CPC H04N 5/4403; G06F 3/011; H04N 2005/4428; H04N 2005/4435

(57) ABSTRACT

A method for remote control includes obtaining motion data generated by a wearable device according to a user motion, generating a remote control signal for controlling a home appliance according to the motion data, and sending the remote control signal to the home appliance.

### CROSS-REFERENCE TO RELATED APPLICATIONS

The present application is based upon and claims priority to Chinese Patent Application No. 201510047939.8, filed Jan. 29, 2015, the entire contents of which are incorporated herein by reference.

### TECHNICAL FIELD

The present disclosure relates to device control and, more particularly, to a method and device for remote control.

### BACKGROUND

A remote controller is an electronic device for controlling operation status of, for example, a home appliance. A remote controller may have many physical buttons. A user has to select a corresponding physical button among the many physical buttons provided on the remote controller and press the selected physical button to control operation status of a home appliance. The operation steps can be cumbersome.

### SUMMARY

In accordance with the present disclosure, there is provided a method for remote control. The method includes obtaining motion data generated by a wearable device according to a user motion, generating a remote control signal for controlling a home appliance according to the motion data, and sending the remote control signal to the home appliance.

Also in accordance with the present disclosure, there is provided another method for remote control. The method includes collecting motion data generated from a user motion, generating a control instruction corresponding to the motion data according to the motion data, and sending a remote control signal to a home appliance according to the control instruction. The remote control signal is configured to control operation status of the home appliance.

Also in accordance with the present disclosure, there is provided a device for remote control including a processor and a memory storing instructions. The instructions, when executed by the processor, cause the processor to obtain motion data generated by a wearable device according to a user motion, generate a remote control signal for controlling a home appliance according to the motion data, and send the remote control signal to the home appliance.

Also in accordance with the present disclosure, there is provided another device for remote control including a processor and a memory storing instructions. The instructions, when executed by the processor, cause the processor to collect motion data generated from a user motion, generate a control instruction corresponding to the motion data according to the motion data, and send a remote control signal to a home appliance according to the control instruction. The remote control signal is configured to control operation status of the home appliance.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the present disclosure.

FIG. 1A is a diagram showing an implementation environment according to an exemplary embodiment.

FIG. 1B is a diagram showing another implementation environment according to another exemplary embodiment.

FIG. 2 is a flowchart showing a method for remote control according to an exemplary embodiment.

FIG. 3 is a flowchart showing a method for remote control according to another exemplary embodiment.

FIG. 4 is a diagram showing a scenario in which the method for remote control provided by the embodiment in FIG. 3 is implemented.

FIG. 5 is a flowchart showing a method for remote control according to another exemplary embodiment.

FIG. 6 is a flowchart showing a method for remote control according to another exemplary embodiment.

FIG. 7A is a schematic diagram showing an interface in which the method for remote control provided by the embodiment in FIG. 6 is implemented.

FIG. 7B is a schematic diagram showing another interface in which the method for remote control provided by the embodiment in FIG. 6 is implemented.

FIG. 8 is a flowchart showing a method for remote control according to another exemplary embodiment.

FIG. 9 is a flowchart showing a method for remote control according to another exemplary embodiment.

FIG. 10 is a diagram showing a scenario in which the method for remote control provided by the embodiment in FIG. 9 is implemented.

FIG. 11 is a block diagram showing a device for remote control according to another exemplary embodiment.

FIG. 12 is a block diagram showing a device for remote control according to another exemplary embodiment.

FIG. 13 is a block diagram showing a device for remote control according to another exemplary embodiment.

FIG. 14 is a block diagram showing a device for remote control according to another exemplary embodiment.

FIG. 15 is a block diagram showing a device for remote control according to another exemplary embodiment.

FIG. 16 is a block diagram showing a device for remote control according to another exemplary embodiment.

FIG. 17 is a block diagram showing a device for remote control according to another exemplary embodiment.

FIG. 18 is a block diagram showing a device for remote control according to another exemplary embodiment.

Through the above accompany drawings, the specific embodiments of the present disclosure have been shown, for which a more detailed description will be given as below. These drawings and textual description are not intended to limit the scope of the concept of the present disclosure in any manner, but to explain the concept of the present disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

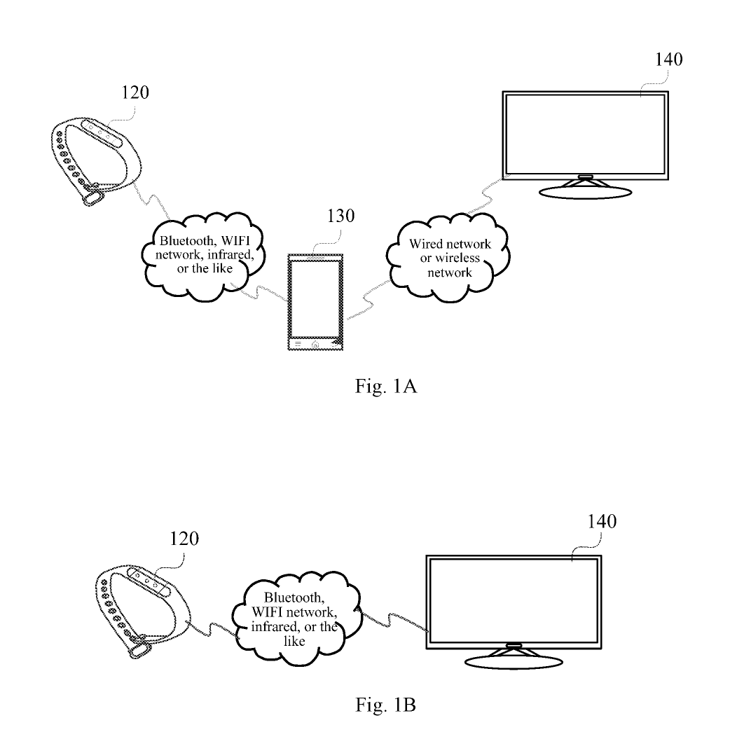

FIG. 1A is a diagram showing an implementation environment according to an exemplary embodiment. The implementation environment shown in FIG. 1A includes a wearable device 120, a user device 130, and a home appliance 140.

The wearable device 120 may be, for example, a smart band, a smart glove, a smart watch, a smart ring, or smart clothing. Usually, various sensors are provided in the wearable device 120, including, for example, a gravity acceleration sensor or a gyro sensor. The wearable device 120 is capable of collecting motion data generated from a user motion through the built-in sensors. The user motion may be one of various gestures/actions. In the illustration in FIG. 1A, the wearable device 120 is shown as a smart band.

The wearable device 120 can be coupled with the user device 130 via Bluetooth or WIFI (Wireless Fidelity) technologies.

The user device 130, which is also referred to as a user terminal, may be an electronic device capable of communicating with the wearable device 120 and the home appliance 140. The user device 130 may be, for example, a smart phone, a smart router, a tablet computer, a server, or a remote controller specially designed for the home appliance 140. In the illustration in FIG. 1A, the user device 130 is shown as a smart phone.

The home appliance 140 may be, for example, a smart TV, an air conditioner, a refrigerator, or a washing machine. In the illustration in FIG. 1A, the home appliance 140 is shown as a smart TV.

FIG. 1B is a diagram showing an implementation environment according to another exemplary embodiment. The implementation environment shown in FIG. 1B includes the wearable device 120 and the home appliance 140. The wearable device 120 can be coupled with the home appliance 140 via Bluetooth or WIFI technologies.

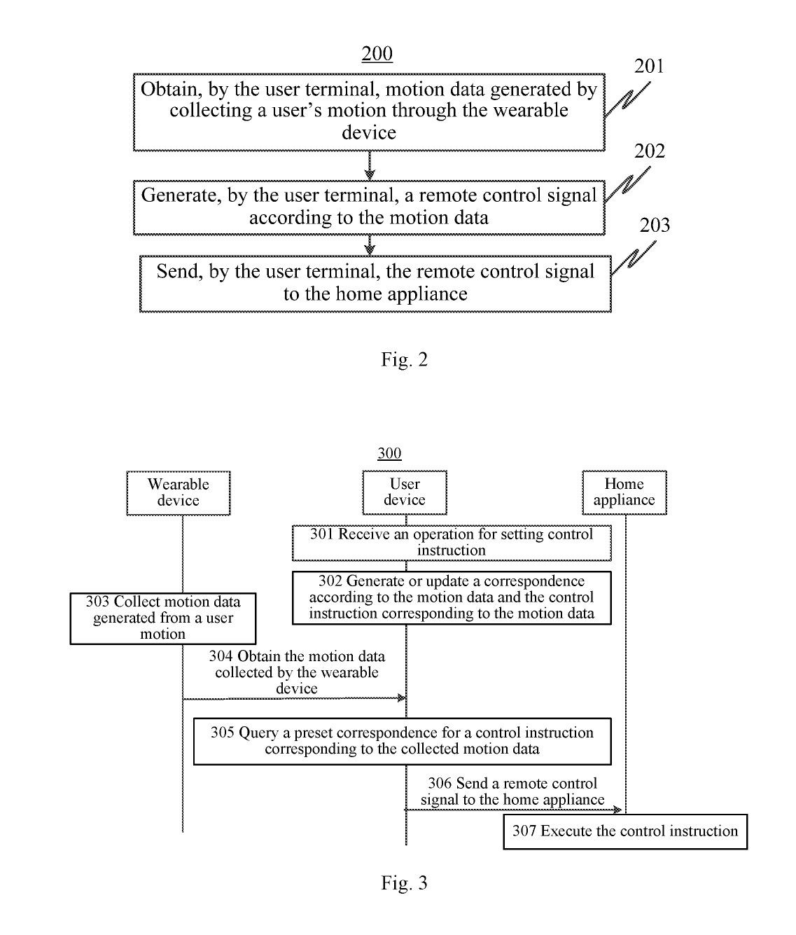

FIG. 2 is a flowchart showing a method 200 for remote control according to an exemplary embodiment. The method 200 may be implemented, for example, in the user device 130. As shown in FIG. 2, at 201, the user terminal 130 obtains motion data generated by the wearable device 120 according to a user motion. At 202, the user terminal 130 generates a remote control signal for controlling the home appliance 140 according to the motion data. The remote control signal is configured to control operation status of the home appliance 140. At 203, the user terminal 130 sends the remote control signal to the home appliance 140.

FIG. 3 is a flowchart showing a method 300 for remote control according to another exemplary embodiment. The method 300 can be implemented, for example, in the user device 130. As shown in FIG. 3, at 301, the user device 130 receives an operation for setting control instruction. In the disclosure, the operation for setting control instruction is also referred to as a “setting operation.” The setting operation is configured to set motion data and a control instruction corresponding to the motion data. The motion data can be sensor data generated by the wearable device 120 according to a user motion. The control instruction is an instruction for controlling the home appliance 140.

In some embodiments, the user device 130 is a device having components for user interaction, for example, a smart phone having a display screen. In this scenario, the user device 130 receives a selection operation by which the user selects a target control instruction from at least one preset control instruction and displays a motion collecting prompt for collecting the motion data generated from the user motion.

In some embodiments, the user device 130 is a device that does not have components for user interaction, for example, a smart router without touch screen or button. In this scenario, the user device 130 establishes a connection with a configuration terminal which may be a personal computer of the user and receives the setting operation triggered by the user via the configuration terminal.

At 302, the user device 130 generates or updates a correspondence between motion data and control instructions according to the collected motion data and the control instruction corresponding to the motion data.

If the user device 130 does not store a correspondence between motion data and control instructions, the user device 130 generates a correspondence according to the collected motion data and the control instruction corresponding to the motion data.

If the user device 130 stores a correspondence between motion data and control instructions, the user device 130 updates the correspondence according to the collected motion data and the control instruction corresponding to the motion data.

An exemplary correspondence among user motions, motion data, and control instructions is shown in Table 1 below. The user device 130 only needs to store the correspondence between motion data and control instructions.

TABLE 1

| | | Control instruction |
|---|---|---|
| | Motion data corresponding to the | corresponding to the |
| User motion | user motion | motion data |
| →↓ | “right + down” motion data | boot |
| ↑ | “up” motion data | volume increase |
| ↓ | “down” motion data | volume decrease |
| [symbol] [symbol] [symbol] | “right down + right up + right down” | media source |
| | motion data | switching |
| → [symbol] → | “right + left down + right” motion | channel switching |
| | data | |

In some embodiments, the correspondence between motion data and control instructions can be defined by the user or can be preset in the user device 130 by the manufacturer. In this scenario, the user device 130 does not need to generate or update the correspondence as described above, and the user can directly use the defined or preset correspondence.

At 303, the wearable device 120 collects motion data generated from a user motion. That is, while the user is using the home appliance 140, if the user wishes to perform a remote control on the home appliance 140, he/she performs a user motion through the wearable device 120 and the wearable device 120 collects the motion data generated from the user motion.

For example, if the user performs a user motion “↓,” through a smart band he/she wears, the smart band collects the motion data corresponding to the user motion “↓”.

At 304, the user device 130 obtains the motion data generated by the wearable device 120 by collecting the user motion. According to the disclosure, the user device 130 can obtain the motion data collected by the wearable device 120 via a WIFI network, an infrared connection, or a Bluetooth connection.

At 305, the user device 130 queries a preset correspondence for a control instruction corresponding to the obtained motion data. The preset correspondence includes at least one piece of motion data and control instruction corresponding to each of the at least one piece of motion data.

For example, if the wearable device 120 collects motion data corresponding to the user motion “↓”, the user device 130 queries, e.g., the correspondence shown in Table 1 for a control instruction corresponding to the motion data, i.e., “volume decrease.”

At 306, the user device 130 generates and sends a remote control signal to the home appliance 140.

In some embodiments, the user device 130 sends the remote control signal to the home appliance 140 via a wired network. For example, the user device 130 is a smart router connected with a smart TV via a wired network, and the smart router can send the remote control signal to the smart TV via the wired network.

In some embodiments, the user device 130 sends the remote control signal to the home appliance 140 via a WIFI network. For example, the user device 130 is a smart router connected with a smart TV via a WIFI network, the smart router can send the remote control signal to the smart TV via the WIFI network.

In some embodiments, the user device 130 sends the remote control signal to the home appliance 140 via an infrared connection. For example, if the user device 130 is a smart phone capable of performing infrared remote control, the smart phone can send the remote control signal to the home appliance 140 via an infrared connection.

In some embodiments, the user device 130 sends the remote control signal to the home appliance 140 via a Bluetooth connection. For example, if the user device 130 is a smart phone having a Bluetooth function and is connected to a smart TV via a Bluetooth connection, the smart phone can send the remote control signal to the home appliance 140 via the Bluetooth connection.

According to the disclosure, the home appliance 140 receives the remote control signal sent by the user device 130.

At 307, the home appliance 140 executes the control instruction. For example, the home appliance 140 may execute the “volume decrease” instruction sent by the user device 130.

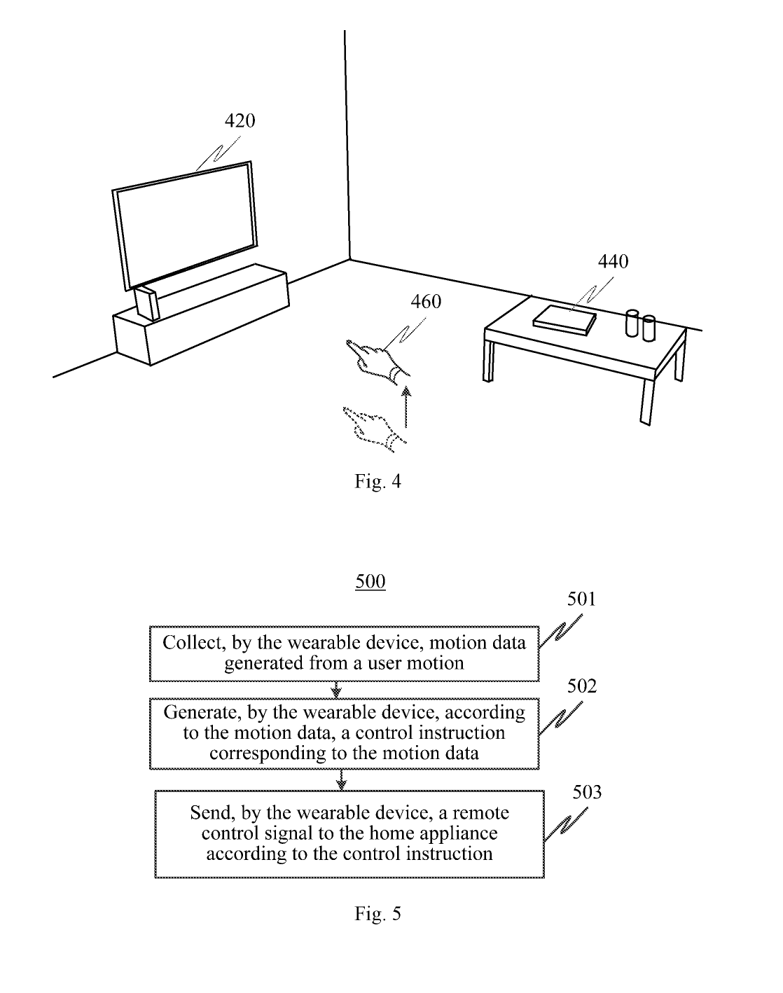

FIG. 4 shows a scenario according to the exemplary method 300. As shown in FIG. 4, a smart TV 420 and a smart router 440 supporting the WIFI technology are mounted in the home of a user. Further, the user also uses a smart band 460. The smart router 440 is configured in advance to store a correspondence between motion data triggered by user gestures through the smart band 460 and corresponding control instructions for the smart TV 420. When the user wants to perform remote control on the smart TV 420, the user may perform a user gesture, for example, an “up” gesture as shown in FIG. 4. The smart band 460 sends the motion data generated by the user gesture to the smart router 440. The smart router 440 queries the control instruction corresponding to the motion data and then sends the control instruction to the smart TV 420 via the WIFI network. The smart TV 420 correspondingly increases the volume. In this scenario, the smart TV 420 and the smart band 460 only need their built-in functions and functions consistent with the present disclosure can be added in the smart router 440. As such, the present disclosure has good applicability. Further, in some embodiments, the smart router 440 can be replaced by a smart phone or a tablet computer.

FIG. 5 is a flowchart showing a method 500 for remote control according to another exemplary embodiment. The method 500 can be implemented, for example, in the wearable device 120 shown in FIG. 1A or 1B. As shown in FIG. 5, at 501, the wearable device 120 collects motion data generated from a user motion.

At 502, the wearable device 120 generates, according to the motion data, a control instruction corresponding to the motion data.

At 503, the wearable device 120 sends a remote control signal to the home appliance 140 according to the control instruction. The remote control signal is configured to control operation status of the home appliance 140.

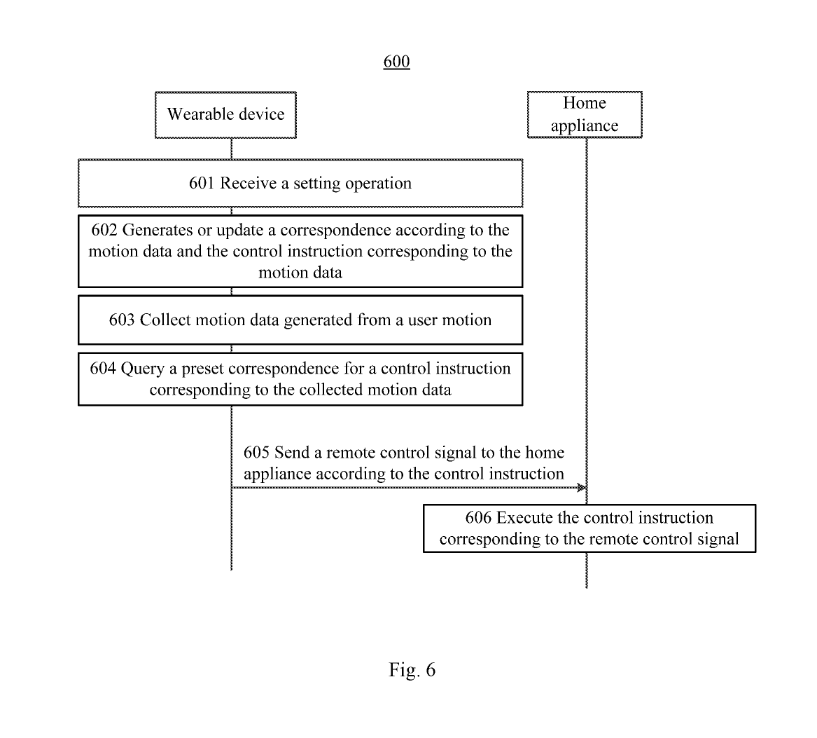

FIG. 6 is a flowchart showing a method 600 for remote control according to another exemplary embodiment. The method 600 can be implemented, for example, in the implementation environment shown in FIG. 1A or 1B. As shown in FIG. 6, at 601, the wearable device 120 receives a setting operation, such as, for example, from a user. The setting operation is configured to set motion data and a control instruction corresponding to the motion data. The motion data is sensor data generated by the wearable device 120 from a user motion. The control instruction is an instruction for controlling the home appliance 140.

In some embodiments, the wearable device 120 is a wearable device having components for user interaction, for example, a smart watch having a touch screen. In this scenario, the wearable device 120 receives a selection operation by which the user selects a target control instruction from at least one preset control instruction and displays a motion collecting prompt for collecting the motion data generated from the user motion.

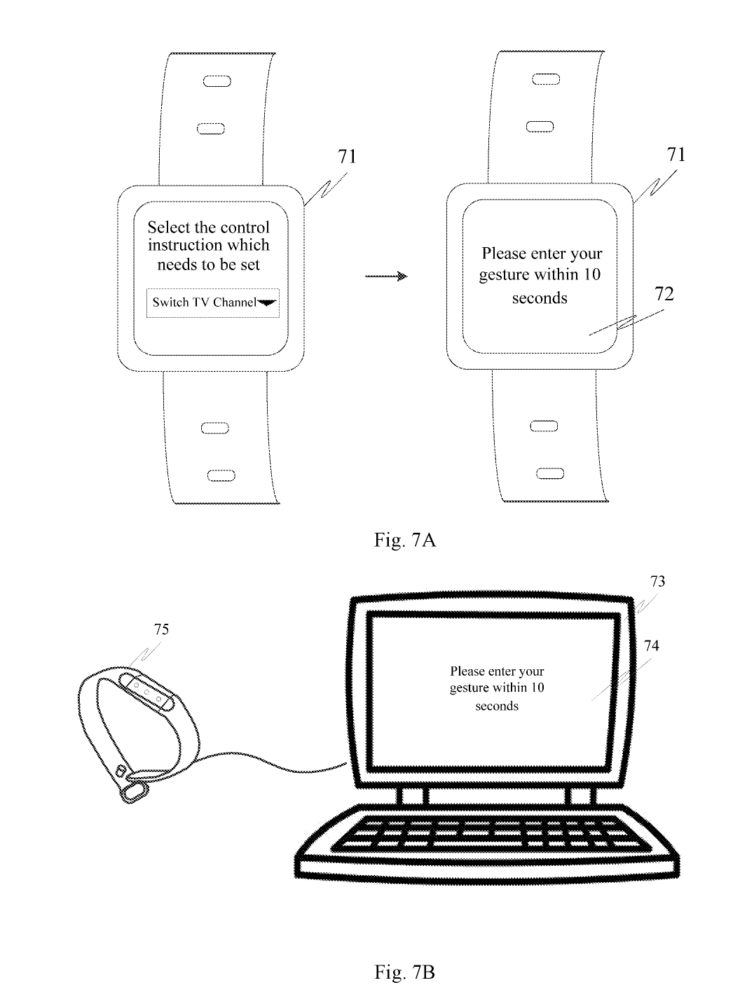

FIG. 7A shows an example in which the wearable device 120 is a smart watch 71 and the home appliance 140 is a smart TV. As shown in FIG. 7A, the user selects a control instruction, “Switch TV Channel,” on the smart watch 71 as a target control instruction. Then, the smart watch 71 displays a motion collecting prompt 72: “Please enter your gesture within 10 seconds.” Then, the user performs a self-defined gesture and the smart watch 71 collects the sensor data generated from the gesture as the motion data.

In some embodiments, the wearable device 120 is a wearable device that does not have components for user interaction, for example, a smart band without touch screen or button. In this scenario, the wearable device 120 establishes a connection with a configuration terminal which may be a personal computer of the user and receives the setting operation triggered by the user via the configuration terminal.

FIG. 7B shows an example in which the wearable device 120 is a smart band 75 and the configuration terminal is a personal computer 73 of the user. The user selects a control instruction, “Switch TV Channel,” on the personal computer 73 as a target control instruction. Then the personal computer 73 displays a motion collecting prompt 74: “Please enter your gesture within 10 seconds.” Then, the user performs a self-defined gesture and the smart band 75 collects the sensor data generated from the gesture as the motion data.

Referring again to FIG. 6, at 602, the wearable device 120 generates or updates a correspondence between motion data and control instructions according to the collected motion data and the control instruction corresponding to the motion data.

If the wearable device 120 does not store a correspondence between motion data and control instructions, the wearable device 120 generates a correspondence according to the collected motion data and the control instruction corresponding to the motion data.

If the wearable device 120 stores a correspondence between motion data and control instructions, the wearable device 120 updates the correspondence according to the collected motion data and the control instruction corresponding to the motion data.

An exemplary correspondence among user motions, motion data, and control instructions is shown in Table 2 below. The wearable device 120 only needs to store the correspondence between motion data and control instructions.

TABLE 2

| | | Control instruction |
|---|---|---|
| | Motion data corresponding | corresponding to the |
| User motion | to the user motion | motion data |
| ↓ [symbol] ↑ | “down + right down + up” motion | start control |
| | data | |
| →↓ | “right + down” motion data | boot |
| ↑ | “up” motion data | instruction for |
| | | volume increase |
| ↓ | “down” motion data | volume decrease |
| [symbol] [symbol] [symbol] | “right down + right up + right down” | media source |
| | motion data | switching |
| → [symbol] → | “right + left down + right” motion | channel switching |
| | data | |

In some embodiments, the correspondence between motion data and control instructions can be defined by the user or can be preset in the wearable device 120 by the manufacturer. In this scenario, the wearable device 120 does not need to generate or update the correspondence as described above, and the user can directly use the defined or preset correspondence.

At 603, the wearable device 120 collects motion data generated from a user motion. That is, while the user is using the home appliance 140, if the user wishes to perform a remote control on the home appliance 140, he/she performs a user motion through the wearable device 120 and the wearable device 120 collects the motion data generated from the user motion.

For example, if the user performs a user motion “↑” through a smart band he/she wears, the smart band collects the motion data corresponding to the user motion “↑”.

At 604, the wearable device 120 queries a preset correspondence for a control instruction corresponding to the collected motion data. The preset correspondence includes at least one piece of motion data and control instruction corresponding to each of the at least one piece of motion data.

For example, if the wearable device 120 collects motion data corresponding to the user motion “↑”, the wearable device 120 queries, e.g., the correspondence shown in Table 2 for a control instruction corresponding to the motion data, i.e., “volume increase.”

At 605, the wearable device 120 sends a remote control signal to the home appliance 140 according to the control instruction.

In some embodiments, the wearable device 120 sends the control instruction to a user device, which generates the remote control signal for controlling the home appliance 140 according to the control instruction and then sends the remote control signal to the home appliance 140.

In some embodiments, the wearable device 120 generates the remote control signal in a WIFI form according to the control instruction and sends the remote control signal to the home appliance 140 via a WIFI network.

In some embodiments, the wearable device 120 generates the remote control signal in an infrared form according to the control instruction and sends the remote control signal to the home appliance 140 via an infrared connection.

In some embodiments, the wearable device 120 generates the remote control signal in a Bluetooth form according to the control instruction and sends the remote control signal to the home appliance 140 via a Bluetooth connection.

At 606, the home appliance 140 executes the control instruction corresponding to the remote control signal. That is, the home appliance 140 parses the control instruction from the remote control signal and executes the control instruction.

In some embodiments, the correspondence between motion data and control instructions can be stored on the home appliance 140.

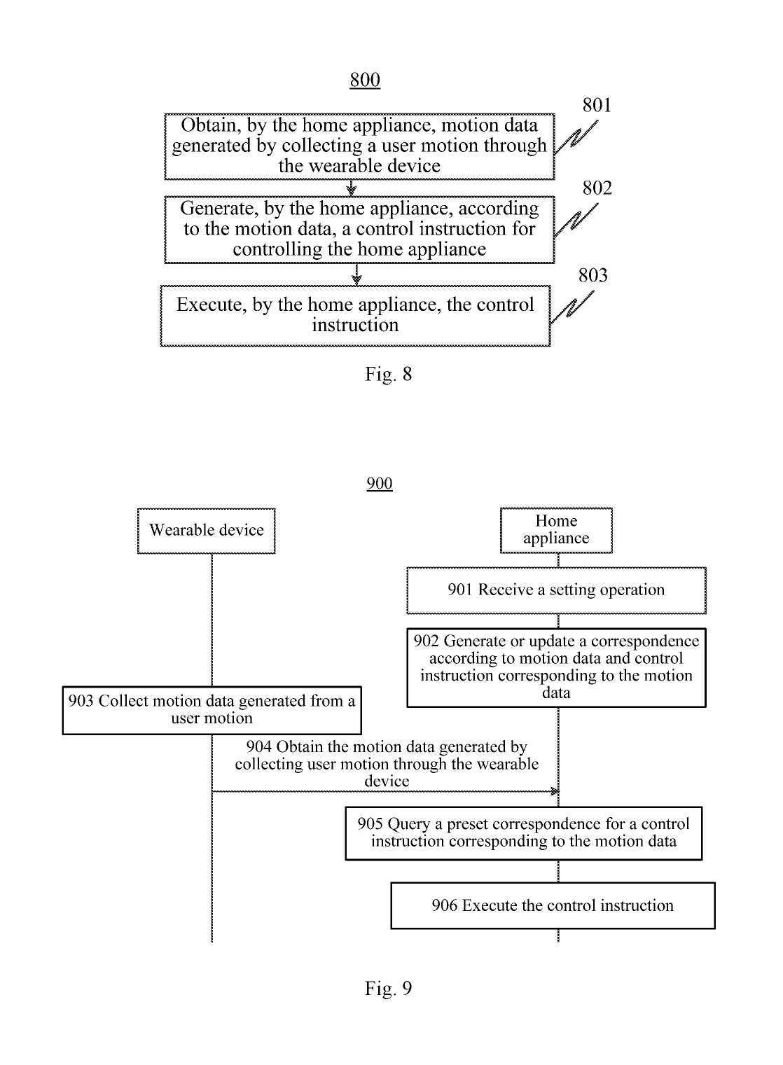

FIG. 8 is a flowchart showing a method 800 for remote control according to another exemplary embodiment. The method 800 can be implemented, for example, in the home appliance 140 shown in FIG. 1A or 1B. As shown in FIG. 8, at 801, the home appliance 140 obtains motion data generated by collecting a user motion through the wearable device 120. At 802, the home appliance 140 generates, according to the motion data, a control instruction corresponding to the motion data. At 803, the home appliance 140 executes the control instruction.

FIG. 9 is a flowchart showing a method 900 for remote control according to another exemplary embodiment. The method 900 can be implemented, for example, in the home appliance 140 shown in FIG. 1A or 1B. As shown in FIG. 9, at 901, the home appliance 140 receives a setting operation, such as, for example, from a user. The setting operation is configured to set motion data and a control instruction corresponding to the motion data. The motion data is sensor data generated by the wearable device 120 from a user motion. The control instruction is an instruction for controlling the home appliance 140.

In some embodiments, the home appliance 140 is a device having components for user interaction, for example, a smart TV having a display screen. In this scenario, the home appliance 140 receives a selection operation by which the user selects a target control instruction from at least one preset control instruction and displays a motion collecting prompt for collecting the motion data generated from the user motion.

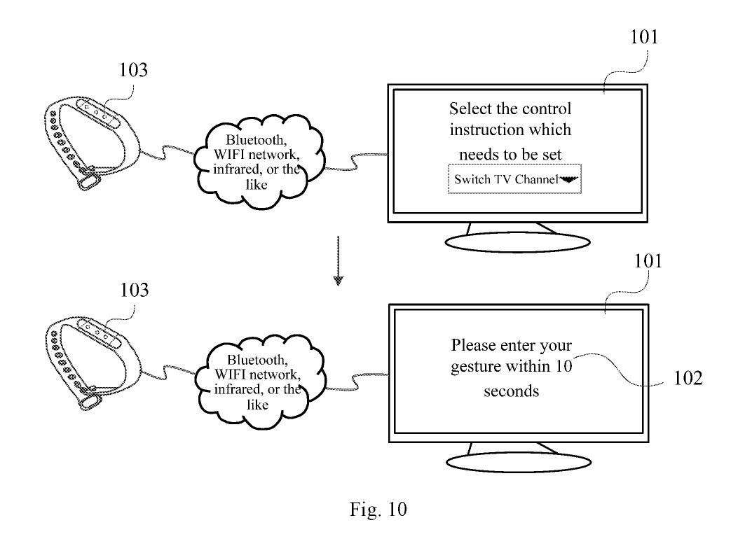

FIG. 10 shows an example in which the wearable device 120 is a smart watch 103 and the home appliance 140 is a smart TV 101. As shown in FIG. 10, the user selects a control instruction, “Switch TV Channel”, on the smart TV 101 as a target control instruction. Then, the smart TV 101 displays a motion collecting prompt 102: “Please enter your gesture within 10 seconds.” Then, the user performs a self-defined gesture and the smart watch 103 collects the sensor data generated from the gesture as the motion data and sends the data to the smart TV 101.

In some embodiments, the home appliance 140 is a device that does not have components for user interaction, for example, a smart bulb having no touch screen or button. In this scenario, the home appliance 140 establishes a connection with a configuration terminal which may be a personal computer of the user and receives the setting operation triggered by the user via the configuration terminal.

At 902, the home appliance 140 generates or updates a correspondence between motion data and control instructions according to the collected motion data and the control instruction corresponding to the motion data.

If the home appliance 140 does not store a correspondence between motion data and control instructions, the home appliance 140 generates a correspondence according to the collected motion data and the control instruction corresponding to the motion data.

If the home appliance 140 stores a correspondence between motion data and control instructions, the home appliance 140 updates the correspondence according to the collected motion data and the control instruction corresponding to the motion data.

An exemplary correspondence among user motions, motion data, and control instructions is shown in, e.g., Table 1 above. The home appliance 140 only needs to store the correspondence between motion data and control instructions.

In some embodiments, the correspondence between motion data and control instructions can be defined by the user or can be preset in the home appliance 140 by the manufacturer. In this scenario, the home appliance 140 does not need to generate or update the correspondence as described above, and the user can directly use the defined or preset correspondence.

At 903, the wearable device 120 collects motion data generated from a user motion. That is, while the user is using the home appliance 140, if the user wishes to perform a remote control on the home appliance 140, he/she performs a user motion through the wearable device 120 and the wearable device 120 collects the motion data generated from the user motion.

For example, if the user performs a user motion “↑” through a smart band he/she wears, the smart band collects the motion data corresponding to the user motion “↑”.

At 904, the home appliance 140 obtains the motion data generated by collecting the user motion through the wearable device 120.

In some embodiments, the home appliance 140 is capable of directly communicating with the wearable device 120, and thus can directly obtain the motion data generated by collecting the user motion through the wearable device 120 via, for example, a WIFI network, an infrared connection, or a Bluetooth connection.

In some embodiments, the home appliance 140 is incapable of directly communicating with the wearable device 120, and thus can obtain, via the user device 130, the motion data generated by collecting the user motion through the wearable device 120. That is, the wearable device 120 sends the motion data to the user device 130, which then sends the motion data to the home appliance 140.

At 905, the home appliance 140 queries a preset correspondence for a control instruction corresponding to the motion data. The preset correspondence includes at least one piece of motion data and a control instruction corresponding to each of the at least one piece of motion data.

For example, if the wearable device 120 collects motion data corresponding to the user motion “↑”, the home appliance 140 queries, e.g., the correspondence shown in Table 2, for a control instruction corresponding to the motion data, i.e., “volume increase.”

At 906, the home appliance 140 executes the control instruction. For example, the home appliance 140 executes the “volume increase” instruction.

In the implementation environment shown in FIG. 1A, a binding relationship between the wearable device 120 and the user device 130 may be established in advance, and a binding relationship between the user device 130 and the home appliance 140 may be established in advance. Thus, the user device 130 may only receive the motion data from the wearable device 120 which is bound to the user device 130. Similarly, the home appliance 140 may only receive the remote control signal from the user device 130 which is bound to the home appliance 140.

According to the present disclosure, the wearable device 120 and the user device 130 can be bound to each other through various approaches. In some embodiments, the user device 130 obtains an ID of the wearable device 120 and binds the ID with the user device 130. The ID of the wearable device 120 may be a two-dimension code adhered to the outside surface of the wearable device 120, and the user device 130 may obtain the ID by scanning the two-dimension code.

In some embodiments, the wearable device 120 sends the ID of the wearable device 120 and a user account to a server (not shown in FIGS. 1A and 1B). The user device 130 sends an ID of the user device 130 and the user account to the server. The server binds the wearable device 120, the user device 130, and the user account according to the ID of the wearable device 120, the ID of the user device 130, and the user account.

In some embodiments, the wearable device 120 sends the ID of the wearable device 120 and the user account to the server via a relay terminal bound to the wearable device 120. The user device 130 sends the ID of the user device 130 and the user account to the server. The server binds the wearable device 120, the user device 130, and the user account according to the ID of the wearable device 120, the ID of the user device 130, and the user account.

In some embodiments, the wearable device 120 sends the ID of the wearable device 120 and the user account to the server via the user device 130. The user device 130 sends the ID of the user device 130 and the user account to the server. The server binds the wearable device 120, the user device 130, and the user account according to the ID of the wearable device 120, the ID of the user device 130, and the user account.

According to the present disclosure, the user device 130 and the home appliance 140 can be bound to each other through various approaches. In some embodiments, the user device 130 obtains an ID of the home appliance 140 and binds the ID with the user device 130. The ID of the home appliance 140 may be a two-dimension code adhered to the outside surface of the home appliance 140. The user device 130 may obtain the ID of the home appliance 140 by scanning the two-dimension code. For example, the user device 130 may be a smart phone and the home appliance 140 may be an air conditioner.

In some embodiments, the home appliance 140 obtains the ID of the user device 130 and binds the ID of the user device 130 with the home appliance 140. The ID of the user device 130 may be a two-dimension code adhered to the outside surface of the user device 130. The home appliance 140 may obtain the ID of the user device 130 by scanning the two-dimension code. For example, the home appliance 140 may be a smart TV and the user device 130 may be a smart router.

In some embodiments, the home appliance 140 sends the ID of the home appliance 140 and a user account to a server. The user device sends the ID of the user device 130 and the user account to the server. The server binds the home appliance 140, the user device 130, and the user account according to the ID of the home appliance 140, the ID of the user device 130, and the user account.

In some embodiments, the home appliance 140 sends the ID of the home appliance 140 and the user account to the server via the user device 130. The user device 130 sends the ID of the user device 130 and the user account to the server. The server binds the home appliance 140, the user device 130, and the user account according to the ID of the home appliance 140, the ID of the user device 130, and the user account.

Similarly, in the implementation environment shown in FIG. 1B, a binding relationship between the wearable device 120 and the home appliance 140 can be established in advance. Thus, the home appliance 140 only receives the remote control signal from the bound wearable device 120.

In some embodiments, the home appliance 140 obtains the ID of the wearable device 120 and binds the ID with the home appliance 140. The ID of the wearable device 120 may be a two-dimension code adhered to the outside surface of the wearable device 120, and the home appliance may obtain the ID of the wearable device 120 by scanning the two-dimension code.

In some embodiments, the wearable device 120 sends the ID of the wearable device 120 and a user account to a server. The home appliance 140 sends the ID of the home appliance 140 and the user account to the server. The server binds the wearable device 120, the home appliance 140, and the user account according to the ID of the wearable device 120, the ID of the home appliance 140 and the user account.

In some embodiments, the wearable device 120 sends the ID of the wearable device 120 and the user account to the server via a relay terminal bound to the wearable device 120. The home appliance 140 sends the ID of the home appliance 140 and the user account to the server. The server binds the wearable device 120, the home appliance 140, and the user account according to the ID of the wearable device 120, the ID of the home appliance 140, and the user account.

In some embodiments, the wearable device 120 sends the ID of the wearable device and the user account to the server via the home appliance 140. The home appliance sends the ID of the home appliance 140 and the user account to the server. The server binds the wearable device 120, the home appliance 140, and the user account according to the ID of the wearable device 120, the ID of the home appliance 140, and the user account.

According to the present disclosure, the ID of the wearable device 120 may be used to uniquely identify the wearable device 120, and the ID of the home appliance 140 may be used to uniquely identify the home appliance 140. The user account sent from the wearable device 120 to the server and the user account sent from the home appliance 140 to the server may be the same.

Exemplary devices consistent with embodiments of the present disclosure for executing methods consistent with embodiments of the present disclosure will be described below. Operations of the exemplary devices are consistent with methods of the present disclosure, such as those discussed above, and thus details of the operations are omitted.

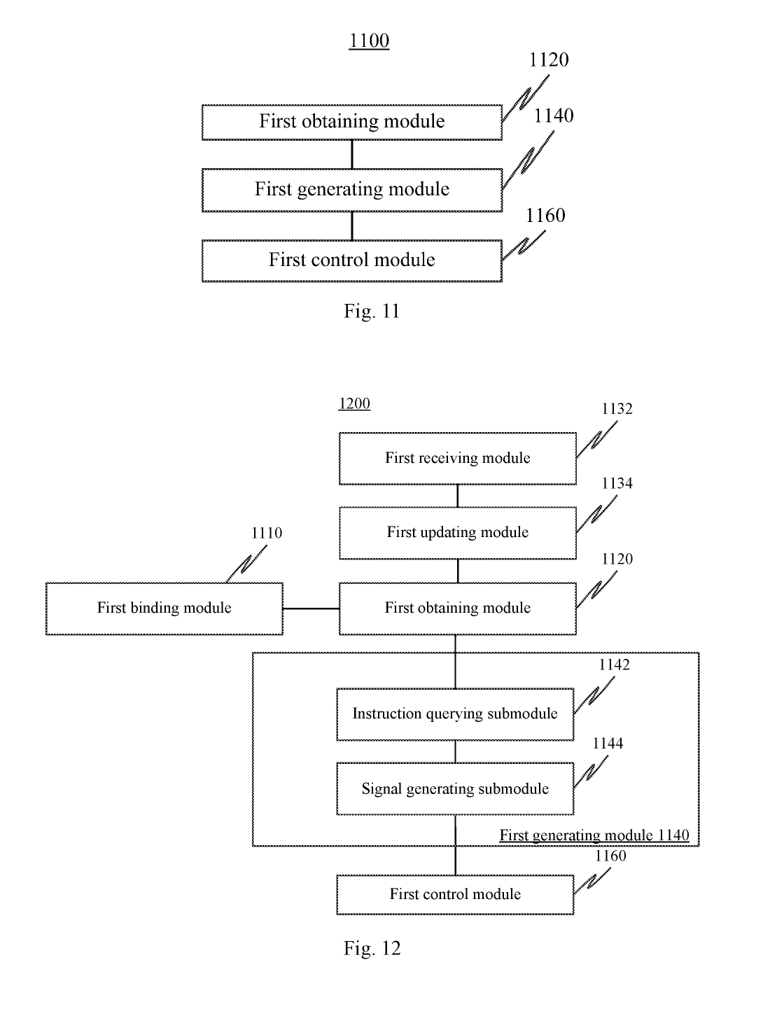

FIG. 11 is a block diagram showing a device 1100 for remote control according to an exemplary embodiment. The device 1100 can be implemented as a part or whole of a user device by software, hardware, or a combination thereof. The user device is capable of communicating with a wearable device and a home appliance. As shown in FIG. 11, the device 1100 includes a first obtaining module 1120 configured to obtain motion data generated by the wearable device according to a user motion, a first generating module 1140 configured to generate a remote control signal for controlling the home appliance according to the motion data, and a first control module 1160 configured to send the remote control signal to the home appliance. The remote control signal is configured to control operation status of the home appliance.

FIG. 12 is a block diagram showing a device 1200 for remote control according to another exemplary embodiment. The device 1200 can be implemented as a part or whole of a user device by software, hardware, or a combination thereof. The user device is capable of communicating with a wearable device and a home appliance. As shown in FIG. 12, the device 1200 includes the first obtaining module 1120, the first generating module 1140, and the first control module 1160.

In some embodiments, as shown in FIG. 12, the first generating module 1140 includes an instruction querying submodule 1142 and a signal generating submodule 1144. The instruction querying submodule 1142 is configured to query a preset correspondence for a control instruction corresponding to the motion data. The preset correspondence includes at least one piece of motion data and a control instruction corresponding to each of the at least one piece of motion data. The signal generating submodule 1144 is configured to generate the remote control signal for controlling the home appliance according to the control instruction.

In some embodiments, as shown in FIG. 12, the device 1200 further includes a first receiving module 1132 and a first updating module 1134. The first receiving module 1132 is configured to receive a setting operation, which is configured to set the motion data and the control instruction corresponding to the motion data. The first updating module 1134 is configured to generate or update the correspondence according to the motion data and the control instruction corresponding to the motion data.

In some embodiments, as shown in FIG. 12, the device 1200 further includes a first binding module 1110 configured to establish a binding relationship with the wearable device in advance.

In some embodiments, the first control module 1160 is configured to send the remote control signal to the home appliance via a wired network, a WIFI network, an infrared connection, or a Bluetooth connection.

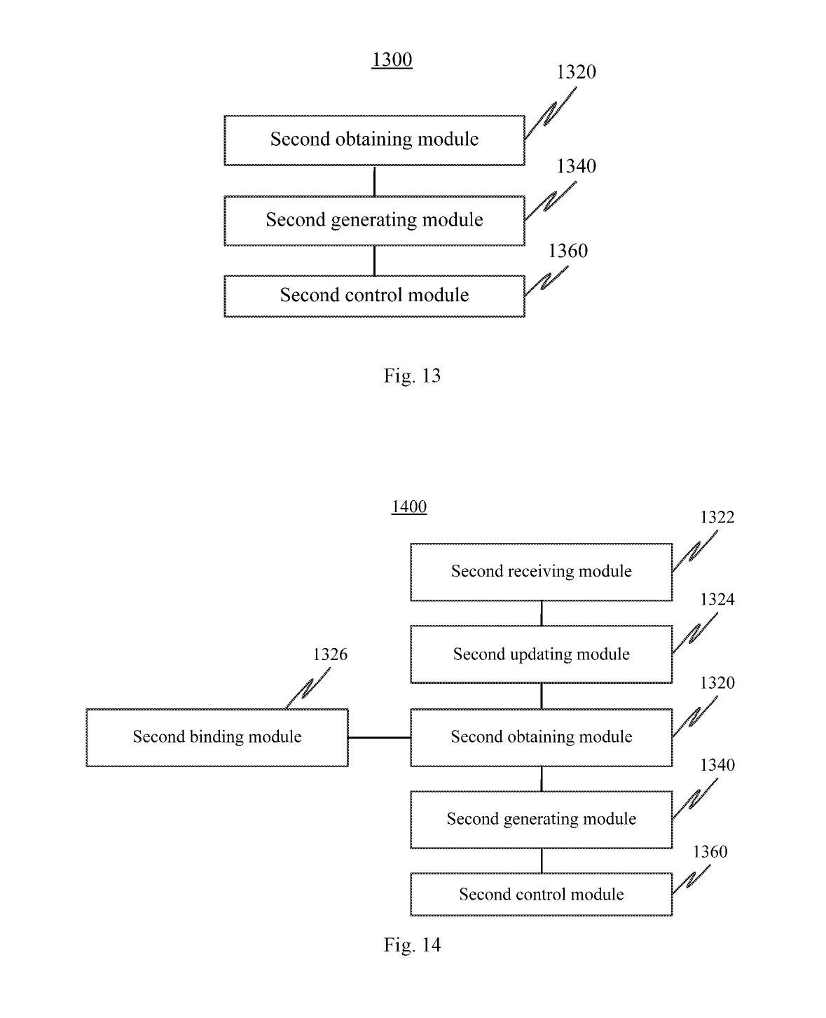

FIG. 13 is a block diagram showing a device 1300 for remote control according to another exemplary embodiment. The device 1300 can be implemented as a part or whole of a wearable device by software, hardware, or a combination thereof. As shown in FIG. 13, the device 1300 includes a second obtaining module 1320 configured to collect motion data generated from a user motion, a second generating module 1340 configured to generate, according to the motion data, a control instruction corresponding to the motion data, and a second control module 1360 configured to send a remote control signal to a home appliance according to the control instruction. The remote control signal is configured to control operation status of the home appliance.

FIG. 14 is a block diagram showing a device 1400 for remote control according to another exemplary embodiment. The device 1400 can be implemented as a part or whole of a wearable device by software, hardware, or a combination thereof. As shown in FIG. 14, the device 1400 includes the second obtaining module 1320, the second generating module 1340, and the second control module 1360.

In some embodiments, the second generating module 1340 is further configured to query a preset correspondence for a control instruction corresponding to the motion data. The preset correspondence includes at least one piece of motion data and a control instruction corresponding to each of the at least one piece of motion data.

In some embodiments, as shown in FIG. 14, the device 1400 further includes a second receiving module 1322 and a second updating module 1324. The second receiving module 1322 is configured to receive a setting operation, which is configured to set the motion data and the control instruction corresponding to the motion data. The second updating module 1324 is configured to generate or update the correspondence according to the motion data and the control instruction corresponding to the motion data.

In some embodiments, the second control module 1360 is further configured to send the control instruction to a user device, which generates the remote control signal for controlling the home appliance according to the control instruction and then sends the remote control signal to the home appliance. In some embodiments, the second control module 1360 is further configured to generate the remote control signal in a WIFI form according to the control instruction and send the remote control signal to the home appliance via a WIFI network. In some embodiments, the second control module 1360 is further configured to generate the remote control signal in an infrared form according to the control instruction and send the remote control signal to the home appliance via an infrared connection. In some embodiments, the second control module 1360 is configured to generate the remote control signal in a Bluetooth form according to the control instruction and send the remote control signal to the home appliance via a Bluetooth connection.

In some embodiments, the device 1400 further includes a second binding module 1326 configured to establish a binding relationship with the home appliance in advance.

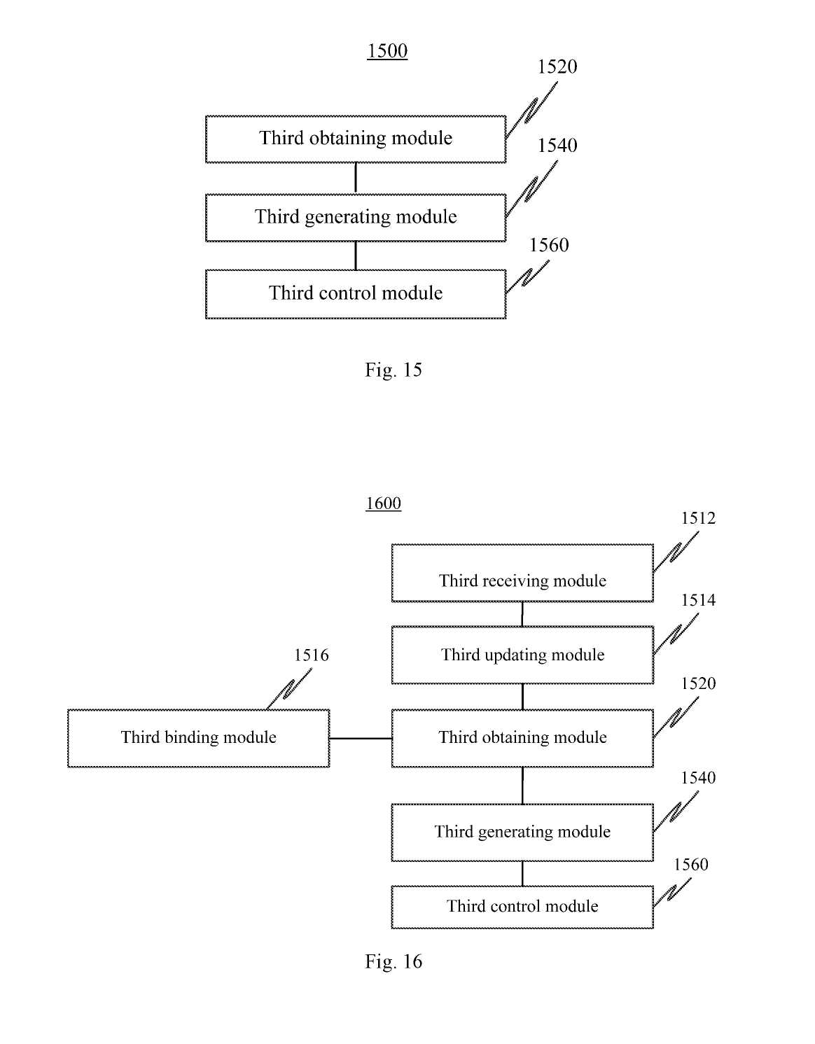

FIG. 15 is a block diagram showing a device 1500 for remote control according to another exemplary embodiment. The device 1500 can be implemented as a part or whole of a home appliance by software, hardware, or a combination thereof. As shown in FIG. 15, the device 1500 includes a third obtaining module 1520 configured to obtain motion data generated by collecting a user motion data through a wearable device, a third generating module 1540 configured to generate, according to the motion data, a control instruction corresponding to the motion data, and a third control module 1560 configured to execute the control instruction.

FIG. 16 is a block diagram showing a device 1600 for remote control according to another exemplary embodiment. The device 1600 can be implemented as a part or whole of a home appliance by software, hardware, or a combination thereof. The device 1600 includes the third obtaining module 1520, the third generating module 1540, and the third control module 1560 configured to execute the control instruction.

In some embodiments, the third generating module 1540 is further configured to query a preset correspondence for a control instruction corresponding to the motion data. The preset correspondence includes at least one piece of motion data and a control instruction corresponding to each of the at least one piece of motion data.

In some embodiments, the device 1600 further includes a third receiving module 1512 and a third updating module 1514. The third receiving module 1512 is configured to receive a setting operation, which is configured to set the motion data and the control instruction corresponding to the motion data. The third updating module 1514 is configured to generate or update the correspondence according to the motion data and the control instruction corresponding to the motion data.

In some embodiments, the third obtaining module 1520 is further configured to receive the motion data sent from a user device, wherein the motion data is sent from the wearable device to the user device. In some embodiments, the third obtaining module 1520 is further configured to obtain the motion data collected by the wearable device via a WIFI network, an infrared connection, or a Bluetooth connection.

In some embodiments, the device 1600 further includes a third binding module 1516 configured to establish a binding relationship with the wearable device in advance.

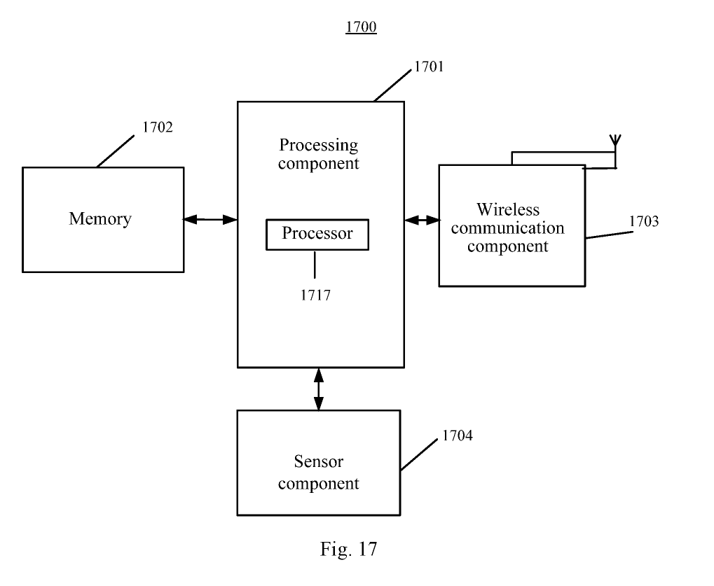

FIG. 17 is a block diagram of a device 1700 for remote control according to another exemplary embodiment. For example, the device 1700 may be a wearable device such as a smart band, a smart watch, or the like.

Referring to FIG. 17, the device 1700 may include one or more of the following components: a processing component 1701, a memory 1702, a wireless communication component 1703, and a sensor component 1704.

The processing component 1701 typically controls overall operations of the device 1700. The processing component 1701 may include one or more processors 1717 to execute instructions to perform all or part of the methods consistent with embodiments of the present disclosure. Moreover, the processing component 1701 may include one or more modules that facilitate the interaction between the processing component 1701 and other components. For instance, the processing component 1701 may include a wireless communication module to facilitate the interaction between the wireless communication component 1703 and the processing component 1701.

The memory 1702 is configured to store various types of data to support the operation of the device 1700. Examples of such data include instructions for any applications or methods operated on the device 1700, time data, location data, gestures, etc. The memory 1702 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The wireless communication component 1703 is configured to facilitate communication between the device 1700 and other devices. The device 1700 can access a wireless network based on a communication standard, including but not limited to WiFi, Bluetooth, or infrared. In one exemplary embodiment, the wireless communication component 1703 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

The sensor component 1704 includes one or more sensors to provide status assessments of various aspects of the device 1700. For instance, the sensor component 1704 may detect at least one of an open/closed status of the device 1700, relative positioning of components of the device 1700, a change in position of the device 1700 or a component of the device 1700, a presence or absence of user contact with the device 1700, an orientation or an acceleration/deceleration of the device 1700, or a change temperature of the device 1700. The sensor component 1704 may include a proximity sensor configured to detect the presence of nearby objects without any physical contact. The sensor component 1704 may also include a health data sensor for collecting health data of a user. The sensor component 1704 may also include a gesture sensor for collecting gestures of a user. In some embodiments, the sensor component 1704 may also include at least one of an accelerometer sensor, a gyroscope sensor, a magnetic sensor, a pressure sensor, a temperature sensor, a pedometer, a heart rate sensor, an electronic compass sensor, or the like.

In exemplary embodiments, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods for remote control on the wearable device side.

In exemplary embodiments, there is also provided a non-transitory computer-readable storage medium including instructions, such as included in the memory 1702, executable by the processor 1717 in the device 1700, for performing methods consistent with embodiments of the present disclosure. For example, the non-transitory computer-readable storage medium may be a ROM, a RAM, a CD-ROM, a magnetic tape, a floppy disc, an optical data storage device, or the like.

In accordance with the present disclosure, there is also provided a non-transitory computer-readable storage medium including instructions that, when executed by the processor 1717 in the device 1700, cause the device 1700 to perform methods for remote control consistent with embodiments of the present disclosure.

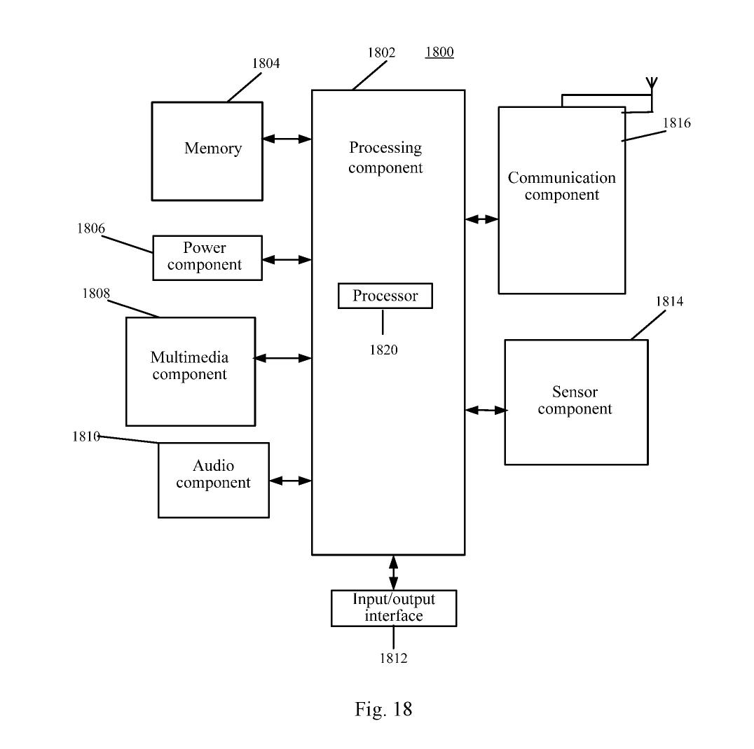

FIG. 18 is a block diagram of a device 1800 for remote control according to another exemplary embodiment. For example, the device 1800 may be a user device such as a mobile phone, a computer, a tablet, a router, a personal digital assistant, or the like. Alternatively, the device 1800 may be a home appliance such as a smart TV, an air conditioner, a washing machine, a refrigerator, or the like.

Referring to FIG. 18, the device 1800 may include one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 typically controls overall operations of the device 1800, such as the operations associated with display, telephone calls, data communications, camera operations, and recording operations. The processing component 1802 may include one or more processors 1820 to execute instructions to perform all or part of the steps in the above described methods. Moreover, the processing component 802 may include one or more modules which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the device 1800. Examples of such data include instructions for any applications or methods operated on the device 1800, contact data, phonebook data, messages, pictures, video, etc. The memory 1804 may be implemented using any type of volatile or non-volatile memory devices, or the combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the device 1800. The power component 1806 may include a power management system, one or more power sources, and other components associated with the generation, management, and distribution of power in the device 1800.

The multimedia component 1808 includes a screen providing an output interface between the device 1800 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and/or the rear camera may receive an external multimedia datum while the device 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone configured to receive an external audio signal when the device 1800 is in an operation mode, such as a call mode, a recording mode, and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor component 1814 includes one or more sensors to provide status assessments of various aspects of the device 1800. For instance, the sensor component 1814 may detect an open/closed status of the device 1800, relative positioning of components, e.g., the display and the keypad, of the device 1800, a change in position of the device 1800 or a component of the device 1800, a presence or absence of user contact with the device 1800, an orientation or an acceleration/deceleration of the device 1800, and a change in temperature of the device 1800. The sensor component 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an accelerometer sensor, a gyroscope sensor, a magnetic sensor, a pressure sensor, or a temperature sensor.

The communication component 1816 is configured to facilitate communication, wired or wirelessly, between the device 1800 and other devices. The device 1800 can access a wireless network based on a communication standard, such as WiFi, 2G, 3G, 4G, or a combination thereof. In one exemplary embodiment, the communication component 1816 receives a broadcast signal or broadcast associated information from an external broadcast management system via a broadcast channel. In one exemplary embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the device 1800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for remote control on the user device side.

In exemplary embodiments, there is also provided a non-transitory computer-readable storage medium including instructions, such as included in the memory 1804, executable by the processor 1820 in the device 1800, for performing methods consistent with embodiments of the present disclosure. For example, the non-transitory computer-readable storage medium may be a ROM, a RAM, a CD-ROM, a magnetic tape, a floppy disc, an optical data storage device, or the like.

In accordance with the present disclosure, there is also provided a non-transitory computer-readable storage medium including instructions when executed by the processor 1820 in the device 1800, causing the device 1800 to perform methods for remote control consistent with embodiments of the present disclosure.

According to the present disclosure, a user can remotely control a home appliance by performing a motion, which is detected by a wearable device, and thus does not need to press any button for remote control. Further, the user can perform remote control on the home appliance by user defined motions. As such, the user does not need to perform cumbersome operation steps as in the conventional methods.

Other embodiments of the present disclosure will be apparent to those skilled in the art from consideration of the specification and practice of the invention disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for remote control, comprising:
obtaining motion data generated by a wearable device according to a user motion;
generating a remote control signal for controlling a home appliance according to the motion data; and
sending the remote control signal to the home appliance.

2. The method according to claim 1, wherein generating the remote control signal includes:
querying a preset correspondence for a control instruction corresponding to the motion data, the preset correspondence including at least one piece of preset motion data and at least one preset control instruction, each of the at least one control instructions corresponding to one of the at least one piece of preset motion data; and
generating the remote control signal according to the control instruction.

3. The method according to claim 2, further comprising:
receiving a setting operation containing a target control instruction to be set;
receiving target motion data generated by the wearable device; and
updating the preset correspondence according to the target motion data and the target control instruction.

4. The method according to claim 1, further comprising:
establishing a binding relationship with the wearable device in advance.

5. The method according to claim 1, wherein sending the remote control signal to the home appliance includes sending the remote control signal to the home appliance via at least one of a wired network, a wireless fidelity network, an infrared connection, or a Bluetooth connection.

6. A method for remote control, comprising:
collecting motion data generated from a user motion;
generating, according to the motion data, a control instruction corresponding to the motion data; and
sending a remote control signal to a home appliance according to the control instruction, the remote control signal being configured to control operation status of the home appliance.

7. The method according to claim 6, wherein generating the control instruction includes:
querying a preset correspondence for the control instruction corresponding to the motion data, the preset correspondence including at least one piece of preset motion data and at least one control instruction, each of the at least one control instructions corresponding to one of the at least one piece of preset motion data.

8. The method according to claim 7, wherein further comprising:
receiving a setting operation containing a target control instruction to be set;
generating target motion data from a target user motion; and
updating the correspondence according to the target motion data and the target control instruction.

9. The method according to claim 6, wherein sending the remote control signal to the home appliance includes:
sending the control instruction to a user device, which generates the remote control signal according to the control instruction and sends the remote control signal to the home appliance; or
generating the remote control signal according to the control instruction and sending the remote control signal to the home appliance via at least one of a WIFI network, an infrared connection, or a Bluetooth connection.

10. The method according to claim 6, further comprising:
establishing a binding relationship with the home appliance in advance.

11. A device for remote control, comprising:
a processor; and
a memory storing instructions that, when executed by the processor, cause the processor to:
obtain motion data generated by a wearable device according to a user motion;
generate a remote control signal for controlling a home appliance according to the motion data; and
send the remote control signal to the home appliance.

12. The device according to claim 11, wherein the instructions further cause the processor to:
query a preset correspondence for a control instruction corresponding to the motion data, the preset correspondence including at least one piece of preset motion data and at least one preset control instruction, each of the at least one control instructions corresponding to one of the at least one piece of preset motion data; and
generate the remote control signal according to the control instruction.

13. The device according to claim 12, wherein the instructions further cause the processor to:
receive a setting operation containing a target control instruction to be set;
receive target motion data generated by the wearable device; and
update the preset correspondence according to the target motion data and the target control instruction.

14. The device according to claim 11, wherein the instructions further cause the processor to:
establish a binding relationship with the wearable device in advance.

15. The device according to claim 11, wherein the instructions further cause the processor to send the remote control signal to the home appliance via at least one of a wired network, a wireless fidelity network, an infrared connection, or a Bluetooth connection.

16. A device for remote control, comprising:
a processor; and
a memory storing instructions that, when executed by the processor, cause the processor to:
collect motion data generated from a user motion;
generate, according to the motion data, a control instruction corresponding to the motion data; and
send a remote control signal to a home appliance according to the control instruction, the remote control signal being configured to control operation status of the home appliance.

17. The device according to claim 16, wherein the instructions further cause the processor to:
query a preset correspondence for the control instruction corresponding to the motion data, the preset correspondence including at least one piece of preset motion data and at least one control instruction, each of the at least one control instructions corresponding to one of the at least one piece of preset motion data.

18. The device according to claim 17, wherein the instructions further cause the processor to:
receive a setting operation containing a target control instruction to be set;
generate target motion data from a target user motion; and
update the correspondence according to the target motion data and the target control instruction.

19. The device according to claim 16, wherein the instructions further cause the processor to:
send the control instruction to a user device, to generate the remote control signal according to the control instruction and send the remote control signal to the home appliance; or
generate the remote control signal according to the control instruction and send the remote control signal to the home appliance via at least one of a WIFI network, an infrared connection, or a Bluetooth connection.

20. The device according to claim 16, wherein the instructions further cause the processor to:
establish a binding relationship with the home appliance in advance.
